(19) United States
(12) Patent Application Publication
(10) Pub. No.: US 2015/0254187 A1
(43) Pub. Date: Sep. 10, 2015

(54) STORAGE DEVICE, INFORMATION PROCESSING APPARATUS, AND CACHE CONTROL PROGRAM

(71) Applicant: FUJITSU LIMITED, Kawasaki-shi (JP)

(72) Inventor: Kazutaka OGIHARA, Hachioji (JP)

(21) Appl. No.: 14/612,321

(22) Filed: Feb. 3, 2015

(30) Foreign Application Priority Data
Mar. 4, 2014 (JP) 2014-042042

(51) Int. Cl. G06F 12/08

(52) U.S. Cl. CPC G06F 12/0873; G06F 12/0875; G06F 2212/452; G06F 2212/461

(57) ABSTRACT

A first cache memory connects to a first storage module and stores part of information in the first storage module. A second cache memory connects to a second storage module and stores information in the second storage module. By using the information stored in the first or the second cache memory, a request processing unit reads or writes information from or to the first and the second storage modules. A change management unit changes connection such that the first storage module connects to the second cache memory. When a change is performed by the change management unit, a read control unit moves the information stored in the first cache memory to the second cache memory.

### CROSS-REFERENCE TO RELATED APPLICATION

This application is based upon and claims the benefit of priority of the prior Japanese Patent Application No. 2014-042042, filed on Mar. 4, 2014, the entire contents of which are incorporated herein by reference.

### FIELD

The embodiments discussed herein are related to a storage device, an information processing apparatus, and a cache control program.

### BACKGROUND

Information processing apparatuses usually include hosts that perform arithmetic processing and storage devices that stores therein data. The storage devices include auxiliary storage units, such as hard disks. The hosts read and write data from and to the auxiliary storage units included in the storage devices.

In order for a host to speed up an access to information stored in an auxiliary storage unit, a buffer storage unit that uses a semiconductor memory is sometimes installed between the auxiliary storage unit and the host. The buffer storage unit used for a disk device is called a disk cache and is sometimes installed in a disk controller that controls the disk device in a storage device. Modules that include disk devices, such as hard disks, are called storage modules. Furthermore, modules that include disk caches are called cache modules.

It is assumed that a disk page managed by each of the cache module is stored in a storage module that is connected to the cache module. The disk page mentioned here corresponds to information stored in a storage area (block) with a fixed length that is previously determined. Furthermore, “managing a disk page” mentioned here means reception of an access request with respect to the disk page and, furthermore, means an exclusive access control, a consistency hold control, and the like are performed on the disk page.

In recent years, the connection relation between cache modules and storage modules can be physically or logically changed during their operation. A change in the connection relation between the cache modules and the storage modules can be used for load distribution. Furthermore, by performing the change, memories included in the cache modules can be used with each other and thus it is possible to increase the efficiency of the entirety of a storage system.

There is a conventional technology related to storage devices that operates a plurality of disk array devices as a single disk array device while moving data between the plurality of disk array devices. Furthermore, there is a conventional technology that, in order to efficiently operate caches, moves a certain piece of data to a cache memory that is included in a controller and that frequently accesses that data.

Patent Document 1: Japanese Laid-open Patent Publication No. 2000-181763

Patent Document 2: Japanese Laid-open Patent Publication No. 2002-182864

Patent Document 3: Japanese Laid-open Patent Publication No. 2009-199540

However, if the connection relation between the cache modules and the storage modules is changed, because cache data that was stored in a storage module at the change source is not present in a storage module at the change destination, it takes a long time to effectively use the cache modules. Consequently, with the conventional change technology, it is difficult to effectively use cache data that was used by the cache module before the change.

Furthermore, even when using the conventional technology that moves data between a plurality of disk array devices, data in a cache module is not moved and thus it is difficult to effectively use cache data that was used by the cache module before the change.

Furthermore, even when using the conventional technology that moves data to a cache that is associated with a controller that has a large number of access times with respect to the data, it is difficult to effectively use data in the cache module when a change is performed.

### SUMMARY

According to an aspect of an embodiment, a storage device includes a first storing unit; a second storing unit; a first cache memory that is connected to the first storing unit and that stores therein part of information stored in the first storing unit; a second cache memory that is connected to the second storing unit and that stores therein part of information stored in the second storing unit; an information processing unit that reads or writes information with respect to the first storing unit and the second storing unit, by using the information stored in the first cache memory or the second cache memory; a change management unit that changes connection such that the first storing unit is connected to the second cache memory; and a move unit that moves, when the change is performed by the change management unit, the information stored in the first cache memory to the second cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an information processing apparatus according to a first embodiment;

FIG. 2 is a schematic diagram illustrating an example of a cache control table;

FIG. 3 is a schematic diagram illustrating an example of a data store table;

FIG. 4 is a schematic diagram illustrating the state of a storage device according to the first embodiment before a change is performed;

FIG. 5 is a schematic diagram illustrating the state of the storage device according to the first embodiment after the change has been performed;

FIG. 6 is a schematic diagram illustrating the state of the storage device according to the first embodiment after cache pages have been moved;

FIG. 7 is a sequence diagram illustrating the flow of a process of moving a cache page according to the first embodiment;

FIG. 8 is a schematic diagram illustrating the state of cache allocation before a change is performed;

FIG. 9 is a schematic diagram illustrating the state of the cache allocation immediately after the change has been performed;

FIG. 10 is a schematic diagram illustrating the state of the cache allocation after the cache page has been moved;

FIG. 11 is a sequence diagram illustrating the flow of a process of moving a cache page according to a second embodiment;

FIG. 12 is a schematic diagram illustrating the state of a storage device according to a third embodiment before a change is performed;

FIG. 13 is a schematic diagram illustrating the state of the storage device according to the third embodiment immediately after the change has been performed;

FIG. 14 is a schematic diagram illustrating a movement of a cache page when data specified by a read request by the storage device according to the third embodiment is present in a cache memory at the move destination;

FIG. 15 is a schematic diagram illustrating a movement of a cache page when the data specified by the read request by the storage device according to the third embodiment is present in a cache memory at the move source;

FIG. 16 is a block diagram illustrating an information processing apparatus according to a fourth embodiment;

FIG. 17 is a flowchart illustrating the flow of a process, performed by a cache module, of performing a write back of cache data;

FIG. 18 is a flowchart illustrating the flow of a process, performed by the cache module, of writing transferred write back data; and

FIG. 19 is a block diagram illustrating an example of the hardware configuration of a cache module.

### DESCRIPTION OF EMBODIMENTS

Preferred embodiments of the present invention will be explained with reference to accompanying drawings. The storage device, the information processing apparatus, and the cache control program disclosed in the present invention are not limited the embodiments described below.

### [a] First Embodiment

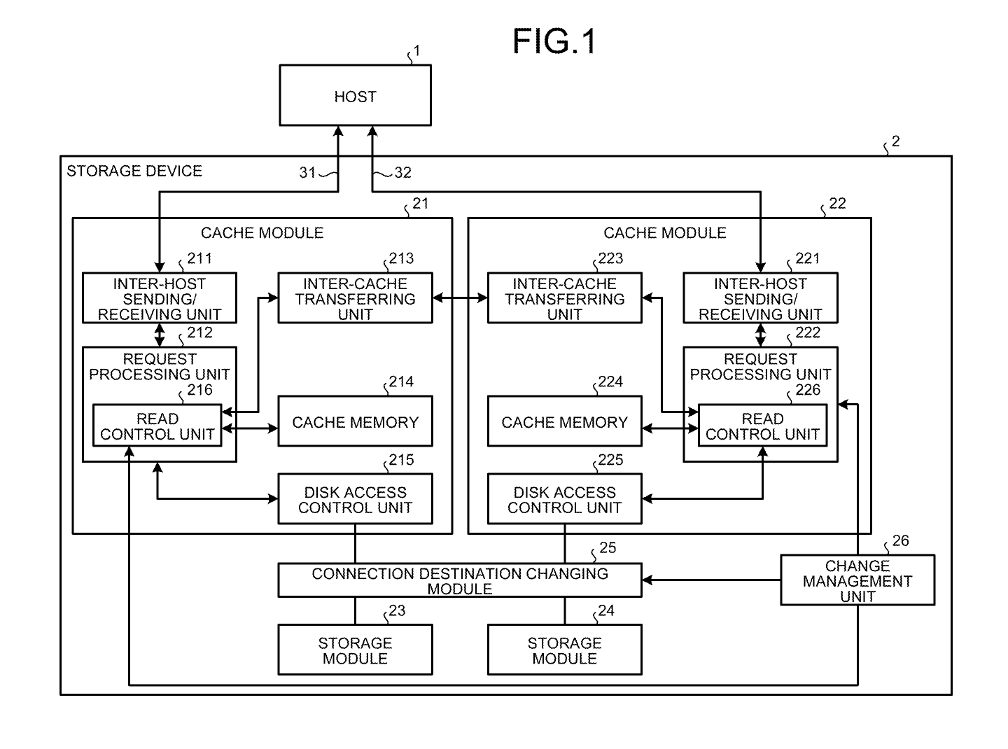

FIG. 1 is a block diagram illustrating an information processing apparatus according to a first embodiment. An information processing apparatus according to the first embodiment includes a host 1 and a storage device 2.

The host 1 is an arithmetic processing unit that executes an application and performs arithmetic processing. Furthermore, the storage device 2 is a storage device that includes a plurality of hard disks. The host 1 and the storage device 2 are connected by communication paths 31 and 32. The communication paths 31 and 32 are, for example, fibre channels. The host 1 reads data from the storage device 2 and writes data into the storage device 2 via the communication paths 31 and 32.

The storage device 2 includes cache modules 21 and 22, storage modules 23 and 24, a connection destination changing module 25, and a change management unit 26. In a description below, when the storage modules 23 and 24 are not distinguished, the storage modules 23 and 24 will be simply referred to as a storage module 20. The storage module 23 mentioned here corresponds to an example of a “first storing unit”. Furthermore, the storage module 24 mentioned here corresponds to an example of a “second storing unit”.

The cache module 21 includes an inter-host sending/receiving unit 211, a request processing unit 212, an inter-cache transferring unit 213, a cache memory 214, and a disk access control unit 215. The request processing unit 212 includes a read control unit 216. The cache memory 214 mentioned here corresponds to an example of a “first cache memory”.

The cache module 22 includes an inter-host sending/receiving unit 221, a request processing unit 222, an inter-cache transferring unit 223, a cache memory 224, and a disk access control unit 225. The request processing unit 222 includes a read control unit 226. The cache memory 224 mentioned here corresponds to an example of a “second cache memory”.

The cache module 21 and the cache module 22 have the same function. Accordingly, in the following, a description will be given of the cache module 21 as an example.

The inter-host sending/receiving unit 211 is connected to the host 1 via the communication path 31. The inter-host sending/receiving unit 211 receives, from the host 1, an input of an I/O request including a read command or a write command with respect to the storage module 20 that is managed by the cache module 21. The “storage module 20 managed by the cache module 21” mentioned here is the storage module 20 to which the cache module 21 is connected and that includes disk pages managed by the cache module 21.

The inter-host sending/receiving unit 211 outputs the received I/O request to the request processing unit 212.

Furthermore, the inter-host sending/receiving unit 211 receives, from the request processing unit 212, a response to the I/O request received from the host 1. Then, the inter-host sending/receiving unit 211 outputs the received response to the host 1.

The request processing unit 212 receives, from the inter-host sending/receiving unit 211, an input of the I/O request. Then, if the I/O request is a write request for data to be written, the request processing unit 212 outputs, to the disk access control unit 215, the write request. The request processing unit 212 mentioned here corresponds to an example of an “information processing unit”.

In contrast, if the I/O request is a read request for data to be read, the request processing unit 212 performs the following process by using the read control unit 216.

The read control unit 216 determines whether the data that is specified to be read is present in the cache memory 214 in the request processing unit 212. If the data that is specified to be read is stored in the cache memory 214, the read control unit 216 reads the data from the cache memory 214. Then, the read control unit 216 outputs, to the inter-host sending/receiving unit 211, the data that has been read as a response to the I/O request.

Furthermore, if the data that is specified to be read is not stored in the cache memory 214, the read control unit 216 outputs a read request to the disk access control unit 215. Then, the read control unit 216 receives, from the disk access control unit 215, an input of the data that has been read from the storage module 20 as a response to the read request. Then, the read control unit 216 outputs, to the inter-host sending/receiving unit 211, the data that has been received as the response to the I/O request. Furthermore, the read control unit 216 stores the received data in the cache memory 214. At this point, if no free space is present in the cache memory 214, the read control unit 216 deletes the data with the oldest access time from the cache memory 214 and then stores the received data in the cache memory 214.

Furthermore, if a change in the connection destination of the storage module 20 that is managed by the cache module 21 occurs, the read control unit 216 receives an instruction to move a cache page from the change management unit 26.

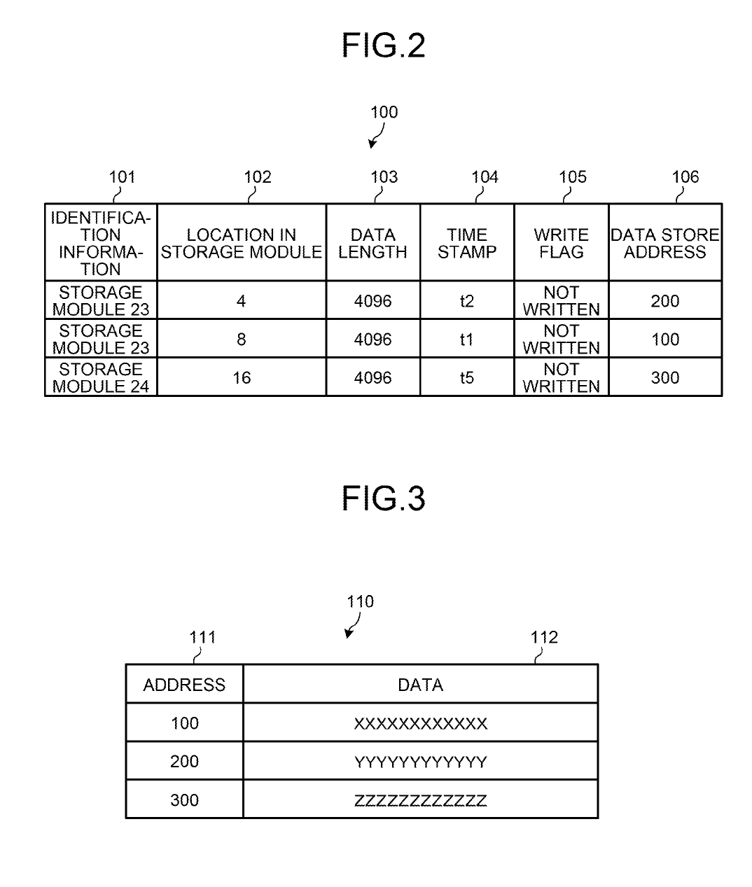

The read control unit 216 stores therein a cache control table 100 illustrated in FIG. 2. FIG. 2 is a schematic diagram illustrating an example of a cache control table.

The cache control table 100 is a table that stores therein information on a cache page. The cache control table 100 stores therein identification information 101 on a storage module in which a cache page is stored, a location 102 in the storage module in which the cache page is stored, and a data length 103 of the cache module. Furthermore, the cache control table 100 stores therein a time stamp 104, a write flag 105, and a data store address 106. The time stamp 104 is the most recent access time with respect to a cache page. The write flag 105 is information indicating whether, when data is deleted from the cache memory 214, the data is to be written in the storage module 20. The flag indicated by “not written” indicates that data is not to be written in the storage module 20. The flag indicated by “written” indicates that data is to be written in the storage module 20. However, the writing of data into the storage module 20 is a process performed when the cache memory 214 is used for a write request. In the first embodiment, because the cache memory 214 is not used for the write request, all of the write flags indicate “not written”. Furthermore, the data store address 106 is information indicating the location, in the cache memory 214, in which data on a certain cache page is stored.

FIG. 3 is a schematic diagram illustrating an example of a data store table. A data store table 110 illustrated in FIG. 3 represents the state, as a table, of data stored in the cache memory 214. As illustrated by the data store table 110, the cache memory 214 stores therein data 112 by being associated with an address 111.

A description will be given here by referring back to FIG. 1. In response to a notification of a movement of a cache page, the read control unit 216 extracts, on the basis of the time stamp 104 in the cache control table 100, a cache page with the most recent access time from among the stored cache pages. Then, the read control unit 216 acquires the data store address 106 of the extracted cache page. Then, the read control unit 216 acquires, from the cache memory 214, data stored in the cache page that is stored in the data store address 106. In a description below, data in a cache page is also simply referred to as a “cache page”. The read control unit 216 outputs the acquired cache page to the inter-cache transferring unit 213. At this time, the read control unit 216 also outputs information related to each of the cache pages stored in the cache control table 100.

The read control unit 216 acquires an instruction to move a cache page from the change management unit 26 until the number of cache pages reaches the number of cache pages that is used for the storage module 20 subjected to a connection change and that is in the cache module 22 that corresponds to the move destination. In a description below, the number of cache pages that is used for the storage module 20 subjected to a connection change and that is in the cache module 22 that corresponds to the move destination is referred to as a “move destination cache page count”. Then, the read control unit 216 moves a cache page every time the read control unit 216 receives an instruction to move the cache page.

Furthermore, if the connection destination of the storage module 20 managed by the cache module 22 is changed to the cache module 21, the read control unit 216 acquires a notification of a deletion of the oldest data from the change management unit 26. The deletion of a cache page is referred to as a purge.

Then, the read control unit 216 receives an input of a cache page stored in the cache module 22 from the inter-cache transferring unit 213. At this time, the read control unit 216 also receives information related to the cache page.

If the free space used for storing therein the received cache page is present in the cache memory 214, the read control unit 216 stores the received cache table in the cache memory 214.

In contrast, if the free space used for storing therein the received cache page is not present in the cache memory 214, the read control unit 216 acquires the most recent access time of the cache page that is received from the cache module 22. Furthermore, the read control unit 216 acquires, form the cache control table 100, the most recent access time of each of the cache pages stored in the cache memory 214. Then, from among the received cache page and the cache pages that are held by the read control unit 216, the read control unit 216 purges the cache page with the oldest access time and stores the rest of the cache pages in the cache memory 214.

The read control unit 216 acquires an instruction to purge the oldest data from the change management unit 26 until the number of cache pages reaches the move destination cache page count in the cache module 21. Then, the read control unit 216 performs a purging process on the oldest data every time an instruction to purge the oldest data is received. The read control unit 216 mentioned here corresponds to an example of a “move unit”.

If a connection change in which the cache module 21 becomes the move source occurs, the inter-cache transferring unit 213 receives cache pages the number of which corresponds to the move destination cache page count from the read control unit 216. Furthermore, the inter-cache transferring unit 213 also receives, from the read control unit 216, information related to the received cache pages. Then, the inter-cache transferring unit 213 outputs the received cache pages and the information related to each of the received cache pages to the inter-cache transferring unit 223.

Furthermore, if a connection change in which the cache module 21 becomes the move destination occurs, the inter-cache transferring unit 213 receives, from the inter-cache transferring unit 223, cache pages the number of which corresponds to the move destination cache page count that is set in the cache module 21 that corresponds to the move destination. Furthermore, the inter-cache transferring unit 213 also receives the information related to each of the received cache pages from the inter-cache transferring unit 223. Then, the inter-cache transferring unit 213 outputs, to the read control unit 216, the received cache pages and the information related to each of the received cache page.

The disk access control unit 215 receives an I/O request from the request processing unit 212. Then, in accordance with the I/O request, the disk access control unit 215 performs a process of reading and writing data with respect to the storage module 23 that is managed by the cache module 21.

The connection destination changing module 25 is a module that has a switch mechanism that changes paths connecting between the disk access control units 215 and 225 and the storage modules 23 and 24. The connection destination changing module 25 receives control of a connection change from the change management unit 26. Then, in accordance with the control performed by the change management unit 26, the connection destination changing module 25 changes the paths connecting between the disk access control units 215 and 225 and the storage modules 23 and 24.

The change management unit 26 receives a change instruction from, for example, an operator. Then, in accordance with the received change instruction, the change management unit 26 controls the path for the connection destination changing module 25. For example, the change management unit 26 receives an instruction indicating the storage module 23 is to be connected to the disk access control unit 225 in the state in which the disk access control unit 215 is connected to the storage module 23. In this case, the change management unit 26 controls the connection destination changing module 25 such that the connection destination of the storage module 23 is changed from the disk access control unit 215 to the disk access control unit 225. In the following, a description will be given an example of a case in which the destination of the storage module 23 is changed from the disk access control unit 215 to the disk access control unit 225.

Furthermore, if a connection change occurs, the change management unit 26 instructs, after the change, the cache modules 21 and 22 to lock an access. Then, the change management unit 26 sends, to the cache module 21 that corresponds to the move source, an instruction to move a cache page. If the cache page is moved from the cache module 21, the change management unit 26 counts the number of moved cache pages. Furthermore, if the cache page is moved from the cache module 21, the change management unit 26 sends, to the cache module 22 that corresponds to the move destination, an instruction to purge the oldest data.

The change management unit 26 stores therein the move destination cache page count of the cache module 21 or 22. Then, if the number of cache pages moved from the cache module 21 that corresponds to the move source reaches the move destination cache page count of the cache module 22, the change management unit 26 releases the access lock of the cache modules 21 and 22 and then ends the movement of the cache page.

The storage modules 23 and 24 are modules each of which includes an auxiliary storage unit, such as a hard disk. Each of the storage modules 23 and 24 are connected to one of the disk access control units 215 and 225 due to a connection change performed by the connection destination changing module 25.

Then, each of the storage modules 23 and 24 is managed by one of the connected disk access control units 215 and 225. For example, if the storage module 23 is managed by the disk access control unit 215, the storage module 23 writes data in accordance with a write request received from the disk access control unit 215. Similarly, if the storage module 23 is managed by the disk access control unit 215, the storage module 23 reads data in accordance with a read request received from the disk access control unit 215 and then outputs the data to the disk access control unit 215.

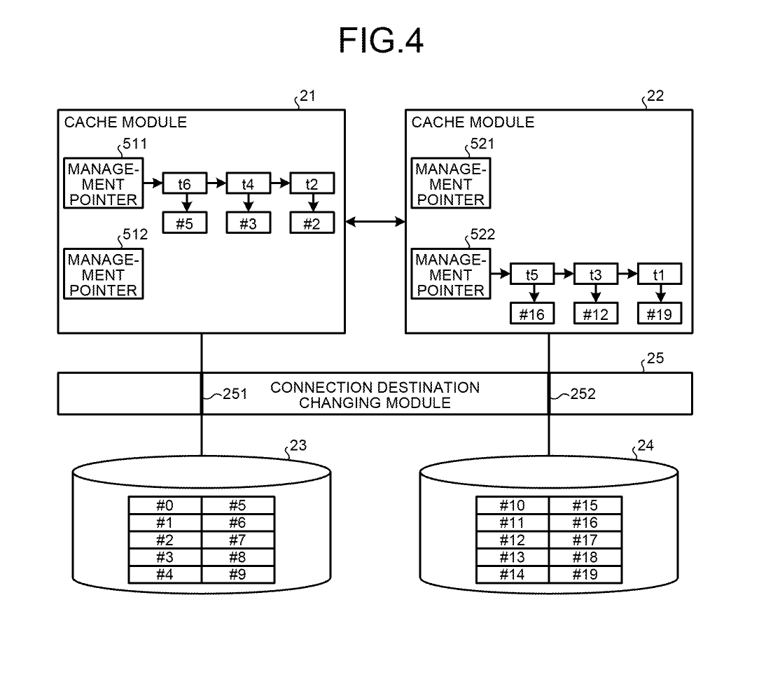

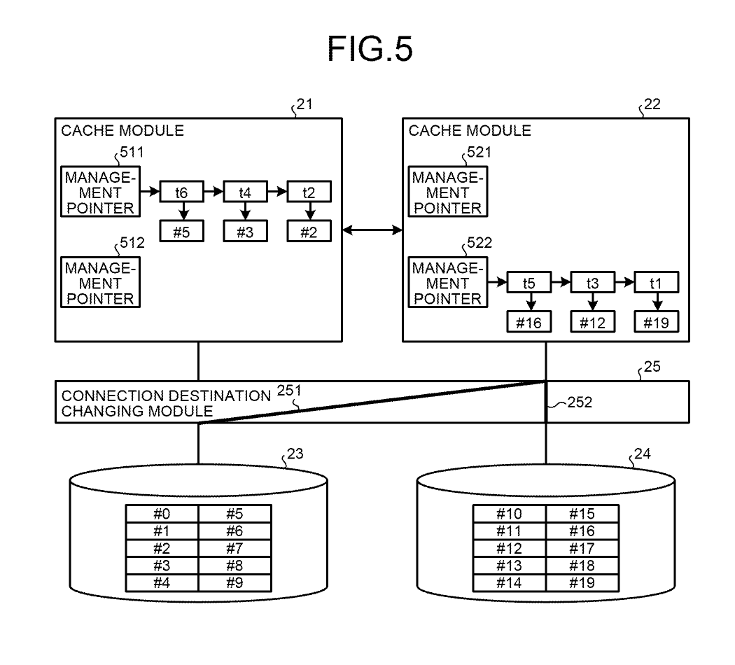

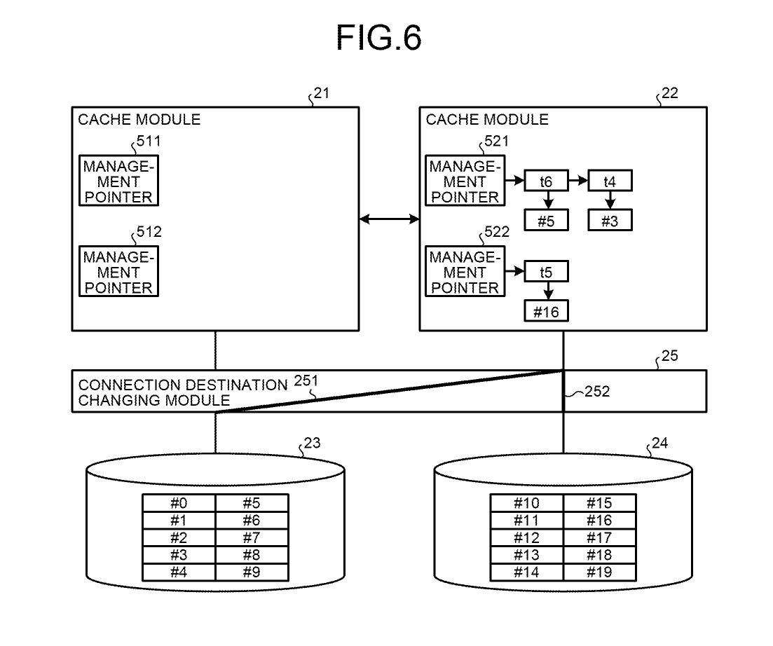

In the following, the overall flow of a movement of a cache page performed at the time of connection change in the information processing apparatus according to the first embodiment will be described with reference to FIGS. 4 to 6. FIG. 4 is a schematic diagram illustrating the state of a storage device according to the first embodiment before a change is performed. FIG. 5 is a schematic diagram illustrating the state of the storage device according to the first embodiment after the change has been performed. FIG. 6 is a schematic diagram illustrating the state of the storage device according to the first embodiment after cache pages have been moved. In FIGS. 4 to 6, for convenience of explanation, units included in the cache module 21 are not illustrated. In a description below, a description will be given of the cache module 21 as the subject of the operation; however, in practice, the units described above perform the process.

Before a connection change, as illustrated in FIG. 4, a connection path 251 for the storage module 23 is connected to the cache module 21. Furthermore, a connection path 252 for the storage module 24 is connected to the cache module 22.

Furthermore, the storage module 23 includes 10 pieces of data. Each of the pieces of the data are stored, in the storage module 23, at the location indicated by #0 to #9 illustrated in FIG. 4. Furthermore, the storage module 24 includes 10 pieces of data. Each of the pieces of the data are stored, in the storage module 24, at the location indicated by #10 to #19 illustrated in FIG. 4. In a description below, each piece of data is indicated by the location of the data. For example, the data stored at the location of #0 in the storage module 23 is represented by “data #0”.

Then, as illustrated in FIG. 4, the cache module 21 includes a management pointer 511 for the cache pages in the storage module 23 and a management pointer 512 for the cache pages in the storage module 24. Furthermore, the cache module 22 includes a management pointer 521 for the cache pages in the storage module 23 and a management pointer 522 for the cache pages in the storage module 24.

Furthermore, at the tip of the arrow extended from the management pointer 511, the most recent access time of the stored cache page. Each access time is connected by the arrow that is extended to the right side. The arrow extending toward the right side indicates that the access time of the cache page at the tip point of the arrow is older than that at the starting point. Namely, as the pointer is closer to the management pointer, the cache page is newly accessed. The access time is represented by “tk”, where the value of k becomes greater as a cache page is more recently accessed. Furthermore, at the tip of the arrow downwardly extending from the access time of each of the cache pages, data stored in the corresponding cache page is indicated. For example, in the cache module 21, the data #2 is stored at the oldest access time t2. Furthermore, in the cache module 21, the data #3 is stored at the second oldest access time t4. Furthermore, in the cache module 21, the data #5 is stored at the most recent access time t6.

Here, FIG. 4 is schematically illustrated for convenience of explanation; however, in practice, the management pointer 511 is included in the read control unit 216. Furthermore, the pieces of the data are stored in the cache memory 214.

The other pieces of the information that are illustrated and that are related to the other management pointers 512 and 522 also indicate the same content as that described about the address time and the data that are associated with the management pointer 511. Furthermore, the access time t1 to t6 indicate the order of accesses with respect to, as the targets, all the pieces of the data stored in both the cache modules 21 and 22.

Then, if the connection destination of the storage module 23 is changed from the cache module 21 to the cache module 22 in the state illustrated in FIG. 4, the state becomes the state illustrated in FIG. 5. Namely, the connection destination of the connection path 251 for the storage module 23 is changed from the cache module 21 to the cache module 22. Namely, in this case, the cache module 21 is the move source and the cache module 22 is the move destination.

Thereafter, the cache pages that were stored in the cache module 21 are moved to the cache module 22 and the state of the storage device 2 becomes the state illustrated in FIG. 6. In this case, it is assumed that the move destination cache page count is 3. Furthermore, the cache module 22 stores therein a maximum of 3 pages.

Specifically, the cache module 21 sequentially sends, to the cache module 22, the cache pages, the number of which corresponds to the move destination cache page count, in the storage module 23 in the order that the access time is new. Then, the cache module 22 purges the oldest cache page from among the cache pages including the received cache page.

For example, the cache module 21 sends, to the cache module 22, the cache page that stores therein the data #5 with the most recent access time t6. The cache module 22 receives the cache page that stores therein the data #5 and then purges the cache page that stores therein the data #19 with the oldest access time t1. Then, the cache module 21 sends, to the cache module 22, the cache page that stores therein the data #3 with the most recent access time t4 from among the stored cache pages. The cache module 22 receives a cache page that stores therein the data #3 and then purges the cache page that stores therein data #12 with the oldest access time t3. Then, the cache module 21 sends, to the cache module 22, the cache page that stores therein the data #2 with the most recent access time t2 from among the stored cache pages. The cache module 22 receives the cache page that stores therein the data #2. In this case, the oldest access time is t2. Accordingly, the cache module 22 purges the cache page that stores therein the received data #2.

Because the move destination cache page count for the storage module 23 managed by the cache module 22 is 3, the number of times a movement of a cache pages ends is three.

By performing the process described above, the state of the storage device 2 after a connection change becomes the state illustrated in FIG. 6.

Then, after the state illustrated in FIG. 6, the cache module 22 manages the storage module 23 by using the cache pages indicated by the management pointer 521 and manages the storage module 24 by using the cache pages indicated by the management pointer 522. Consequently, the cache module 22 can use the cache pages that were used by the storage module 23 held by the cache module 21 immediately after the change.

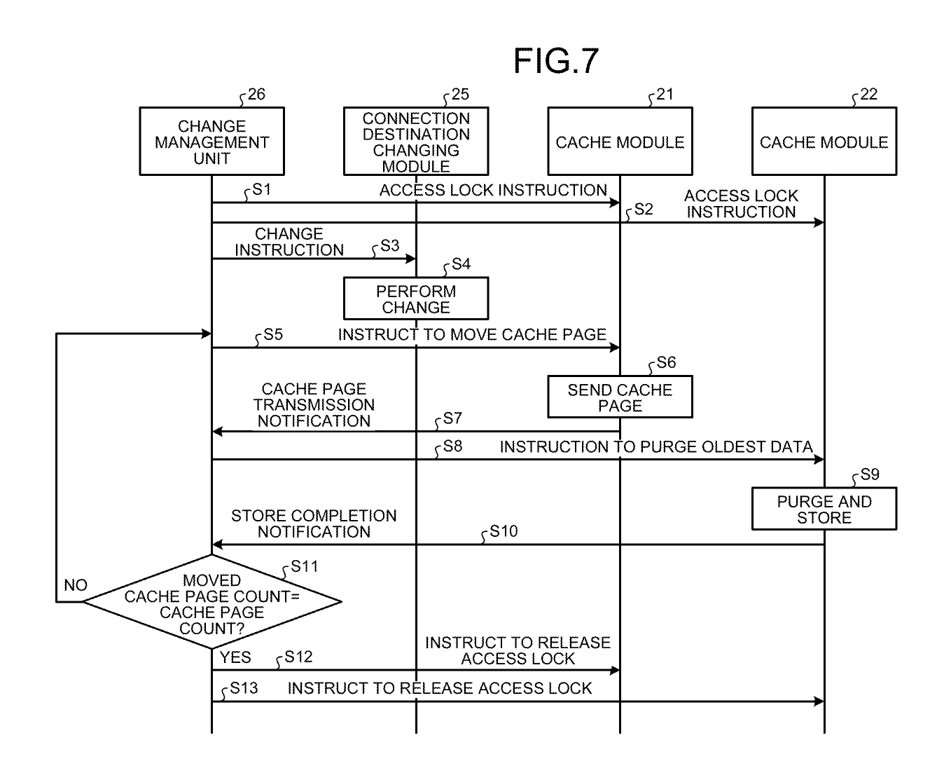

In the following, the overall flow of a process of moving a cache page will be described with reference to FIG. 7. FIG. 7 is a sequence diagram illustrating the flow of a process of moving a cache page according to the first embodiment. Here, a description will be given of a case in which a change is performed from the cache module 21 to the cache module 22.

The change management unit 26 instructs the cache module 21 to perform an access lock (Step S1). In response to this, the cache module 21 performs the access lock. Furthermore, the change management unit 26 instructs the cache module 22 to perform an access lock (Step S2). In response to this, the cache module 22 performs the access lock.

Then, the change management unit 26 sends an instruction to change connection to the connection destination changing module 25 (Step S3). The connection destination changing module 25 changes the connection destination of the storage module 23 from the cache module 21 to the cache module 22 (Step S4).

The change management unit 26 notifies the cache module 21 of an instruction to move a cache page (Step S5).

When the cache module 21 receives the instruction to move the cache page, the cache module 21 sends the cache page with the most recent access time to the cache module 22 (Step S6). Then, the cache module 21 sends a cache page transmission notification to the change management unit 26 (Step S7).

When the change management unit 26 receives the cache page transmission notification, the change management unit 26 sends an instruction to purge the oldest data to the cache module 22 (Step S8).

When the cache module 22 receives the instruction to purge the oldest data, the cache module 22 stores the cache page in the cache memory 214 if any space for storing the received cache page remains. Furthermore, if no space for storing the received cache page remains in the cache memory 214, the cache module 22 performs the purging process on the oldest data and then stores the remaining cache pages in the cache memory 214 (Step S9). Then, the cache module 22 sends a completion notification of the storing to the change management unit 26 (Step S10).

The change management unit 26 counts the number of moved cache pages. Then, the change management unit 26 determines whether the number of moved cache pages reaches the move destination cache page count (Step S11). If the number of moved cache pages does not reach the move destination cache page count (No at Step S11), the change management unit 26 returns to Step S5.

In contrast, if the number of moved cache pages reaches the move destination cache page count (Yes at Step S11), the change management unit 26 sends an instruction to release the access lock to the cache module 21 (Step S12). In response to this, the cache module 21 releases the access lock. Furthermore, the change management unit 26 sends an instruction to release the access lock to the cache module 22 (Step S13). In response to this, the cache module 22 releases the access lock.

As described above, the storage device according to the first embodiment moves, when a change in the cache modules connected to the storage modules is performed, the storage device moves a cache page from the cache module at the move source to the cache module at the move destination. Consequently, the cache module at the move destination can use, immediately after the change, the cache page that was stored in the storage module at the move source and that was subjected to the connection change. Thus, the cache page can be effectively used and the performance of the storage system can be improved.

Furthermore, it is conceivable that data with the new access time is frequently used, the hit rate of cache can be improved by moving data with more recent access time and thus the performance of the storage system can be further improved. In the first embodiment, a description has been given of a case of using the access time; however, another index may also be used as long as the index that can be used to specify data that is frequently used. For example, the number of times of accesses or the like may also be used for the index of the data movement.

### [b] Second Embodiment

In the following, a second embodiment will be described. With a storage module according to the second embodiment, a cache module also holds, in a cache memory, data in a storage module that is not managed by the cache module. Then, the cache module that manages that storage module can use data that is stored in another cache module for a read process performed on that storage module, which differs from the first embodiment.

An information processing apparatus according to the second embodiment is also represented by the block diagram illustrated in FIG. 1. In a description below, descriptions of processes performed by the units described in the first embodiment will be omitted. In the following, a description will be given of a case in which, as the state before a change, the cache module 21 manages the storage module 23 and the cache module 22 manages the storage module 24.

The read control unit 216 compares the access frequency of the storage module 23 managed by the cache module 21 with the access frequency of the storage module 24 managed by the cache module 22. If the access frequency of the storage module 23 is higher that of the storage module 24 by a predetermined value, the read control unit 216 outputs, to the inter-cache transferring unit 213, the cache pages the number of which corresponds to the move destination cache page count that is set in the cache module 22.

Furthermore, if the access frequency of the storage module 24 is higher than that of the storage module 23 by the predetermined value, the read control unit 216 receives the cache pages the number of which corresponds to the move destination cache page count in the cache module 21 from the inter-cache transferring unit 213. Then, the read control unit 216 stores the received cache pages in the cache memory 214.

In a description below, a process of storing, in a cache memory in a cache module, data stored in a storage module that is not managed by that cache module is referred to as “cache page allocation”.

If a connection change in which the cache module 21 becomes the move source occurs, the read control unit 216 receives an instruction to move a cache page from the change management unit 26. Then, the read control unit 216 outputs the cache page with the most recent access time to the inter-cache transferring unit 213. The read control unit 216 repeatedly outputs the cache pages until the cache pages the number of which corresponds to the move destination cache page count in the cache module 22 have been moved.

In contrast, if a connection change in which the cache module 21 becomes the move destination occurs, the read control unit 216 receives an instruction to move the oldest cache page from the change management unit 26. Then, the read control unit 216 receives a cache page from the inter-cache transferring unit 213. If free space that is used to store the received cache page is present in the cache memory 214, the read control unit 216 stores the received cache page in the cache memory 214.

In contrast, if no free space that is used to store the received cache page is present in the cache memory 214, the read control unit 216 outputs the cache page with the oldest access time to the inter-cache transferring unit 213 and stores the remaining cache pages in the cache memory 214.

If a connection change in which the cache module 21 becomes the move source occurs, the inter-cache transferring unit 213 receives an input of the cache page stored in the cache memory 214 from the read control unit 216. Then, the inter-cache transferring unit 213 outputs the received cache page to the inter-cache transferring unit 223. The read control unit 216 repeatedly stores and outputs a cache page until the cache pages the number of which corresponds to the move destination cache page count in the cache module 21 have been moved.

Furthermore, if a connection change in which the cache module 21 becomes the move destination occurs, the inter-cache transferring unit 213 receives an input of the cache page stored in the cache memory 224 from the inter-cache transferring unit 223. Then, the inter-cache transferring unit 213 sends the received cache page to the read control unit 216.

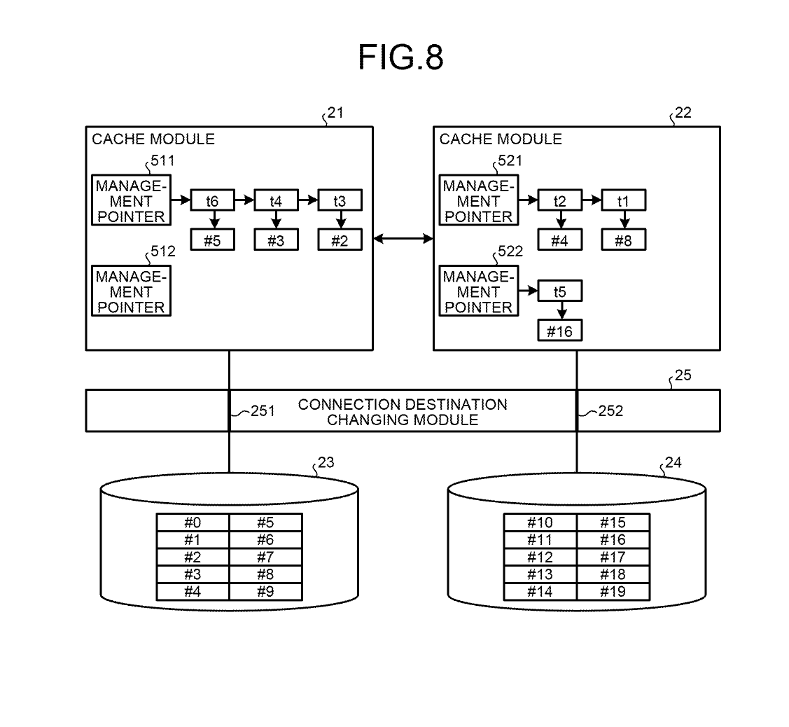

In the following, a description will be given of, in detail with reference to FIGS. 8 to 10, a movement of a cache page according to the second embodiment when allocation of cache pages to be used for storage module 23 is performed on the cache module 22 that does not manage the storage module 23.

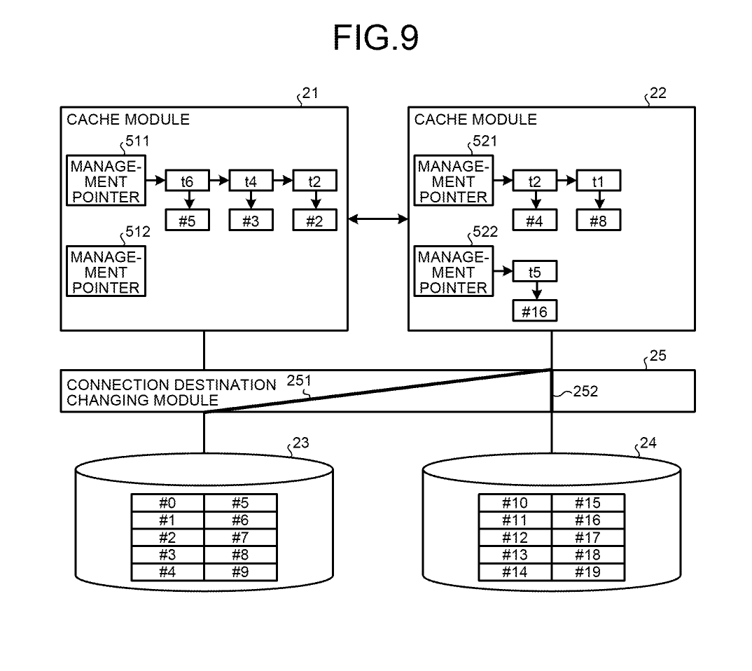

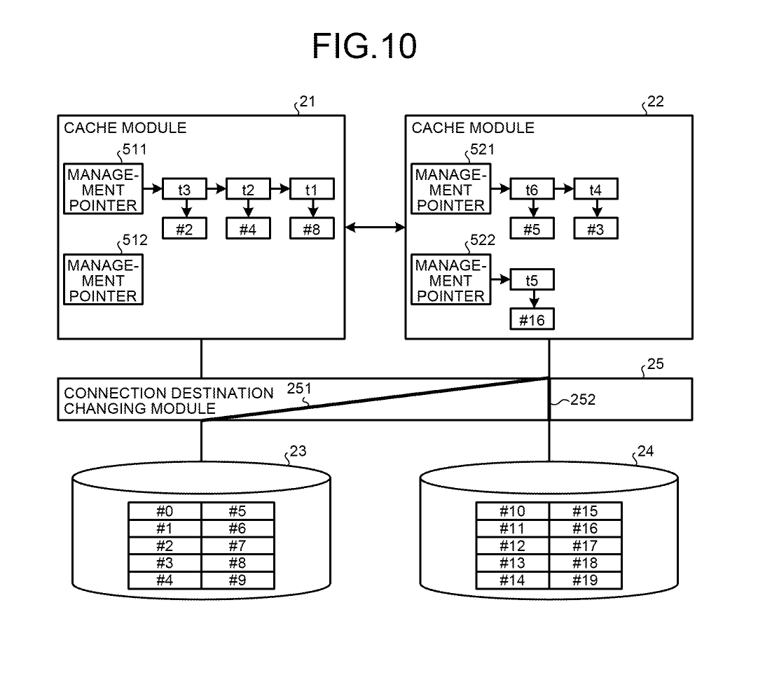

FIG. 8 is a schematic diagram illustrating the state of cache allocation before a change is performed. FIG. 9 is a schematic diagram illustrating the state of the cache allocation immediately after the change has been performed. FIG. 10 is a schematic diagram illustrating the state of the cache allocation after the cache page has been moved. In FIGS. 8 to 10, for convenience of explanation, units included in the cache module 21 are not illustrated. In a description below, a description will be given of a cache module as the subject of the operation; however, in practice, the units described above perform the process.

Furthermore, in a description below, it is assumed that the move destination cache page count that is set in the cache module 22 is 2. Furthermore, it is assumed that the upper limit of the cache page count that can be stored in the cache module 22 is 3.

Before a change, as illustrated in FIG. 8, the connection path 251 for the storage module 23 is connected to the cache module 21. Furthermore, the connection path 252 for the storage module 24 is connected to the cache module 22. Furthermore, because allocation of cache pages is performed, the cache page that stores therein data #4 and the cache page that stores therein data #8 in the storage module 23 are allocated to the management pointer 521 for the storage module 23 managed by the cache module 22.

Then, if the state of the connection destination of the storage module 23 illustrated in FIG. 8 is changed from the cache module 21 to the cache module 22, the state becomes the state illustrated in FIG. 9. Namely, the connection destination of the connection path 251 for the storage module 23 is changed from the cache module 21 to the cache module 22. Namely, in this case, the cache module 21 becomes the move source and the cache module 22 becomes the move destination.

Thereafter, the cache page that was stored in the cache module 21 is moved to the cache module 22 and the state of the storage device 2 becomes the state illustrated in FIG. 10.

Specifically, the cache module 21 sends, to the cache module 22, the cache page that stores therein the data #5 with the most recent access time t6. The cache module 22 receives the cache page that stores therein the data #5 and then sends the cache page that stores therein the data #8 with the oldest access time t1 to the cache module 21. The cache module 21 receives the cache page that stores therein the data #8 and then stores the cache page.

Then, the cache module 21 sends, to the cache module 22, the cache page that stores therein the data #3 with the access time t4 that is the most recent access time from among the stored cache pages. The cache module 22 receives the cache page that stores therein the data #3 and then sends the cache page that stores therein the data #4 with the oldest access time t2 to the cache module 21. The cache module 21 receives the cache page that stores therein the data #4 and stores the cache page.

Because the move destination cache page count for the storage module 23 managed by the cache module 22 is 2, a movement of a cache page is ended at this state.

By performing the process described above, the storage device 2 becomes the state illustrated in FIG. 10 after the connection change.

Then, after the state illustrated in FIG. 10, the cache module 22 manages the storage module 23 by using the cache page indicated by the management pointer 521 and manages the storage module 24 by using the cache page indicated by the management pointer 522. Accordingly, the cache module 22 can be used immediately after the change in the cache page used for the storage module 23 that was held by the cache module 21.

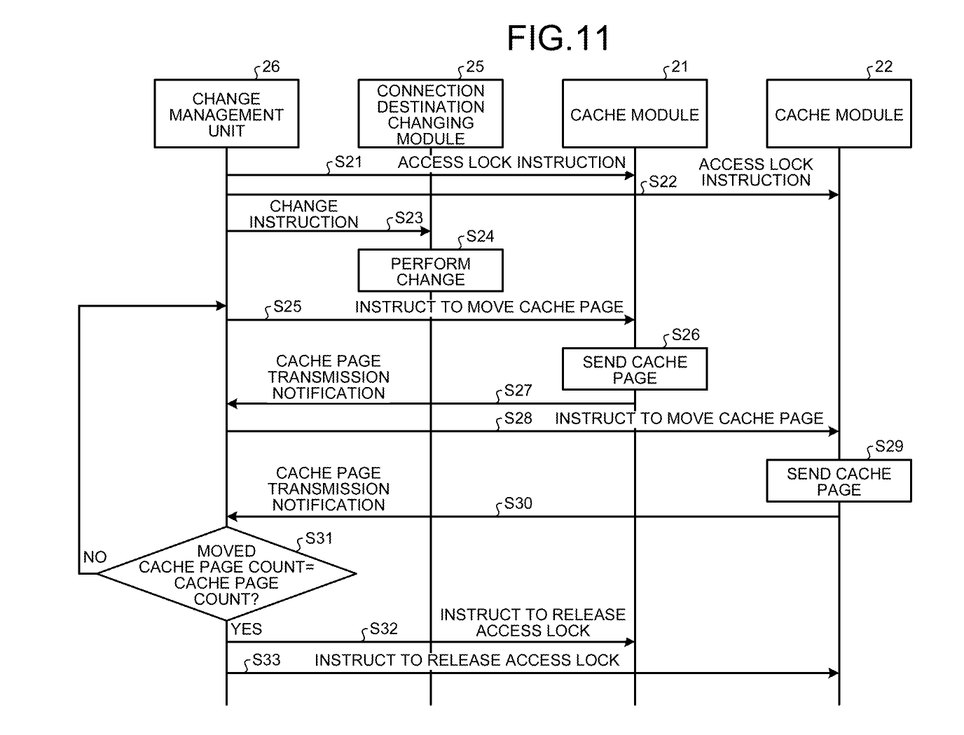

In the following, the overall flow of a process of moving a cache page will be described with reference to FIG. 11. FIG. 11 is a sequence diagram illustrating the flow of a process of moving a cache page according to a second embodiment. Here, a description will be given of a case in which a change from the cache module 21 to the cache module 22 is performed.

The change management unit 26 instructs the cache module 21 to perform an access lock (Step S21). In response to this, the cache module 21 performs the access lock. Furthermore, the change management unit 26 instructs the cache module 22 to perform the access lock (Step S22). In response to this, the cache module 22 performs the access lock.

Then, the change management unit 26 sends, to the connection destination changing module 25, an instruction to change connection (Step S23). The connection destination changing module 25 changes the connection destination of the storage module 23 from the cache module 21 to the cache module 22 (Step S24).

The change management unit 26 notifies the cache module 21 of an instruction to move a cache page (Step S25).

When the cache module 21 receives the instruction to move the cache page, the cache module 21 sends the cache page with the most recent access time to the cache module 22 (Step S26). Then, the cache module 21 sends a cache page transmission notification to the change management unit 26 (Step S27).

When the change management unit 26 receives the cache page transmission notification, the change management unit 26 sends an instruction to move the oldest cache page to the cache module 22 (Step S28).

When the cache module 22 receives the instruction to move the oldest cache data, if space for storing the received cache page remains in the cache memory 214, the cache module 22 stores the cache page. Furthermore, if no space for storing the received cache page remains in the cache memory 214, the cache module 22 sends the oldest cache page to the cache module 21 and then stores the rest of the cache pages in the cache memory 214 (Step S29). Then, the cache module 22 sends the cache page transmission notification to the change management unit 26 (Step S30).

The change management unit 26 calculates the number of moved cache pages. Then, the change management unit 26 determines whether the number of moved cache pages reaches the move destination cache page count (Step S31). If the number of moved cache pages does not reach the move destination cache page count (No at Step S31), the change management unit 26 returns to Step S25.

In contrast, if the number of moved cache pages reaches the move destination cache page count (Yes at Step S31), the change management unit 26 sends an instruction to release the access lock to the cache module 21 (Step S32). In response to this, the cache module 21 releases the access lock. Furthermore, the change management unit 26 sends an instruction to release the access lock to the cache module 22 (Step S33). In response to this, the cache module 22 releases the access lock.

As described above, with the storage device according to the second embodiment, even when allocation of cache pages is performed, if a connection change occurs, a cache page with the most recent access time can be moved to a cache module at the move destination. Consequently, the cache module at the move destination can manage the storage module 23 by using the cache page with a more recent access time. If the access time is new, it is conceivable that the cache page is data with high use probability. Consequently, the cache module at the move destination holds the data that is high use probability in a cache memory and thus the use efficiency of a storage device can be improved.

### [c] Third Embodiment

In the following, a third embodiment will be described. A storage module according to the third embodiment differs from that described in the first and the second embodiments in that the storage module adds information indicating that, immediately after a connection change, a cache page has been stored before the change and, thereafter, moves the cache page in accordance with a read request. In the third embodiment, a description will be given of a case in which a function is added to the configuration used in the second embodiment.

An information processing apparatus according to the third embodiment is also represented by the block diagram illustrated in FIG. 1. In a description below, descriptions of processes performed by the units described in the second embodiment will be omitted. In the following, a description will be given of a case in which, the cache module 21 manages the storage module 23 and the cache module 22 manages the storage module 24.

The read control unit 216 adds, to each cache page, information that is used to determine whether a cache page is the currently used cache page or is only used before a change. For example, the read control unit 216 has a current management pointer and a pre-change management pointer. Then, the read control unit 216 determines that the cache page allocated to a change management pointer after a change as the cache page that is only used before the change and determines that the cache page allocated to a current management pointer after the change as the cache page that is to be currently used. In the following, a movement of a cache page in the read control unit 216 will be described in detail. Furthermore, in a description below, for convenience of explanation, a description will be given of a case in which the read control unit 216 and the read control unit 226 directly send and receive data; however, in practice, the read control unit 216 and the read control unit 226 send and receive the data via the inter-cache transferring units 213 and 223.

The read control unit 216 includes the cache control table 100 that indicates information on the cache page allocated to the current management pointer (see FIG. 2). Furthermore, the read control unit 216 includes the cache control table 100 that indicates information on the cache page allocated to the pre-change management pointer.

First, the read control unit 216 allocates the cache page in the storage module 23 to the current management pointer used for the storage module 23. Furthermore, before a connection change is performed, the read control unit 216 allocates the cache page in the allocated storage module 24 to the current management pointer for the storage module 23.

Then, if a connection change in which the cache module 21 becomes the move source occurs, the read control unit 216 receives a notification indicating the connection change from the change management unit 26. Furthermore, if the read control unit 216 receives, from the read control unit 226, a request for a cache page to be exchanged, the read control unit 216 outputs the specified cache page to the read control unit 226. Furthermore, the read control unit 216 receives another cache page from the read control unit 226. Then, the read control unit 216 stores the received cache page in the cache memory 214.

In contrast, if a connection change in which the cache module 21 becomes the move destination occurs, the read control unit 216 receives a notification indicating the connection change from the change management unit 26. Then, the read control unit 216 reallocates, to the pre-change management pointer for the storage module 24, the cache page that is stored in the storage module 24 and that is allocated to the current management pointer for the storage module 24.

Thereafter, the read control unit 216 receives a read request with respect to the storage module 24 from the inter-host sending/receiving unit 211. Then, the read control unit 216 determines whether the data specified by the read request is present one of the cache memory 214 and the cache memory 224 or is not present in both the cache memory 214 and the cache memory 224.

If the data is not present in both the cache memories 214 and 224, the read control unit 216 reads the data from the storage module 24 and outputs the data to the inter-host sending/receiving unit 211. Furthermore, the read control unit 216 stores the sent data in the cache memory 214 and then allocates the data to the current management pointer for the storage module 24. At this point, if no free space is present in the cache memory 214, the read control unit 216 purges the cache page with the oldest access time from among the cache pages that are allocated to the pre-change management pointer for the storage module 24.

Furthermore, if data is present in the cache page that is allocated to the pre-change management pointer for the storage module 24 for the cache memory 214, the read control unit 216 allocates the cache page to the current management pointer for the storage module 24. Furthermore, the read control unit 216 sends the data read from the cache page to the inter-host sending/receiving unit 211.

Furthermore, if the data is present in the cache page that is allocated to the current management pointer for the storage module 24 managed by the cache memory 224, the read control unit 216 performs the following process.

If no free space is present in the cache memory 214, the read control unit 216 specifies a cache page to be exchanged. Specifically, the read control unit 216 specifies, as the cache page to be exchanged, the cache page with the oldest access time from among the cache pages allocated to the pre-change management pointer for the storage module 24. Then, the read control unit 216 notifies the read control unit 226 that the cache page that stores therein the specified data is exchanged for the cache page that is targeted for the exchange. Thereafter, the read control unit 216 sends the cache page targeted for the exchange to the read control unit 226. Furthermore, the read control unit 216 receives the cache page that stores therein the specified data from the read control unit 226. The read control unit 216 stores the received cache page in the cache memory 214 and allocates the cache page to the current management pointer for the storage module 24. Furthermore, the read control unit 216 sends the data read from the cache page to the inter-host sending/receiving unit 211.

If any free space is present in the cache memory 214, the read control unit 216 receives the cache page that stores therein the specified data from the read control unit 226. The read control unit 216 stores the received cache page in the cache memory 214 and allocates the cache page to the current management pointer for the storage module 24. Furthermore, the read control unit 216 sends the data read from the cache page to the inter-host sending/receiving unit 211.

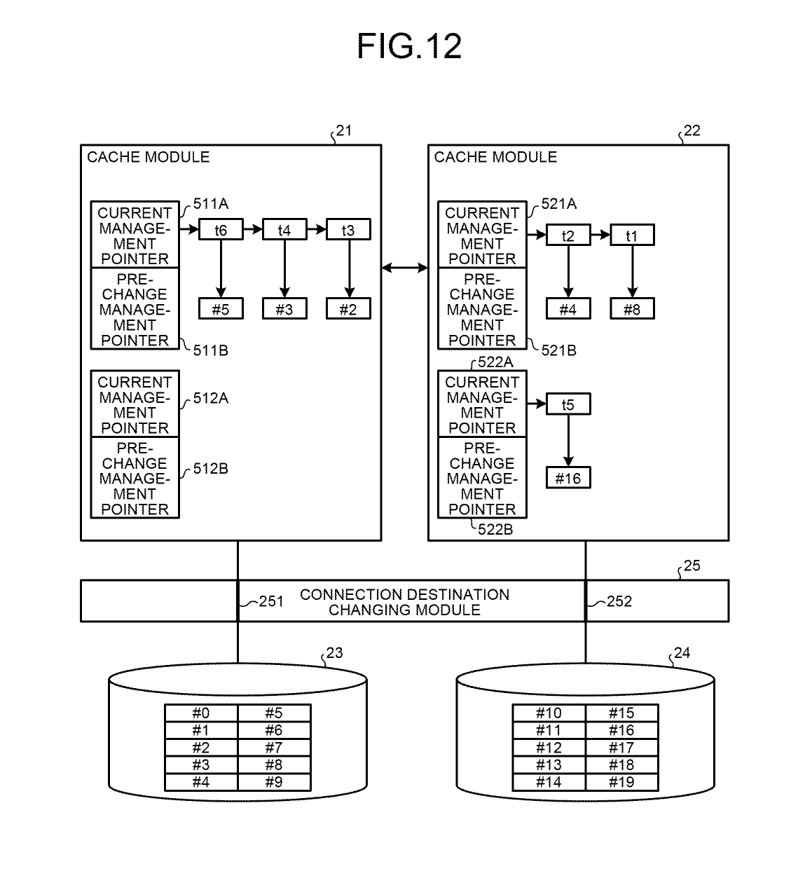

In the following, a movement of a cache page according to the third embodiment will be described in detail with reference to FIGS. 12 to 15.

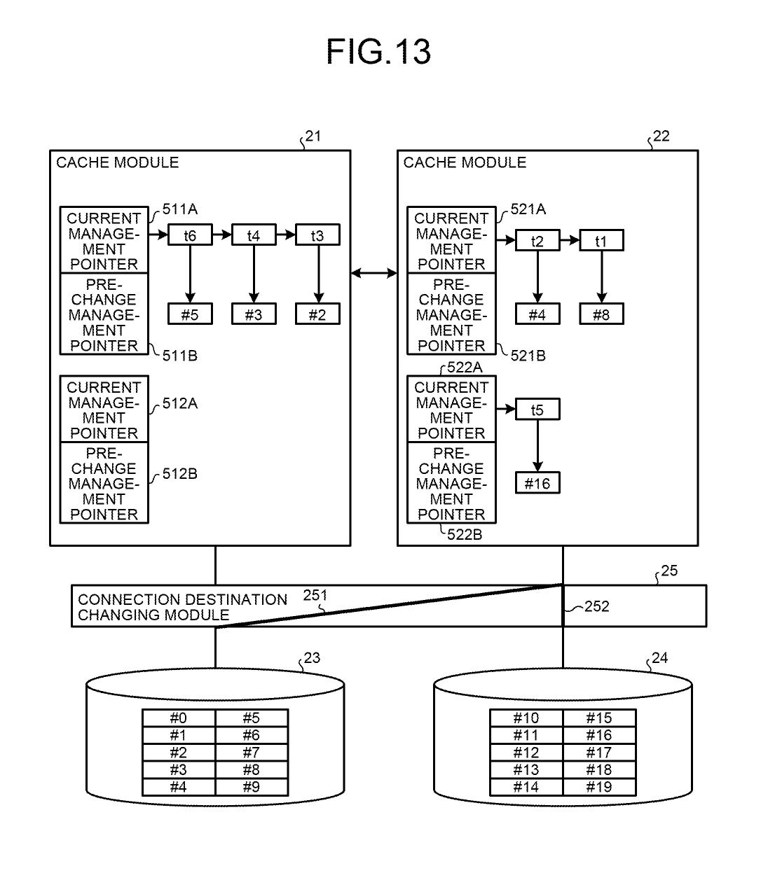

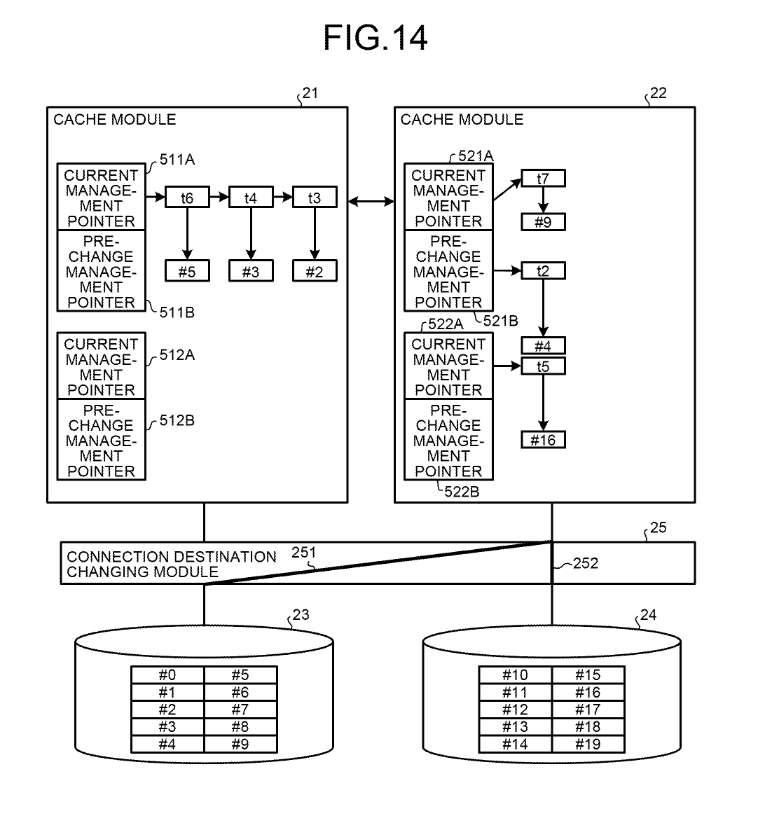

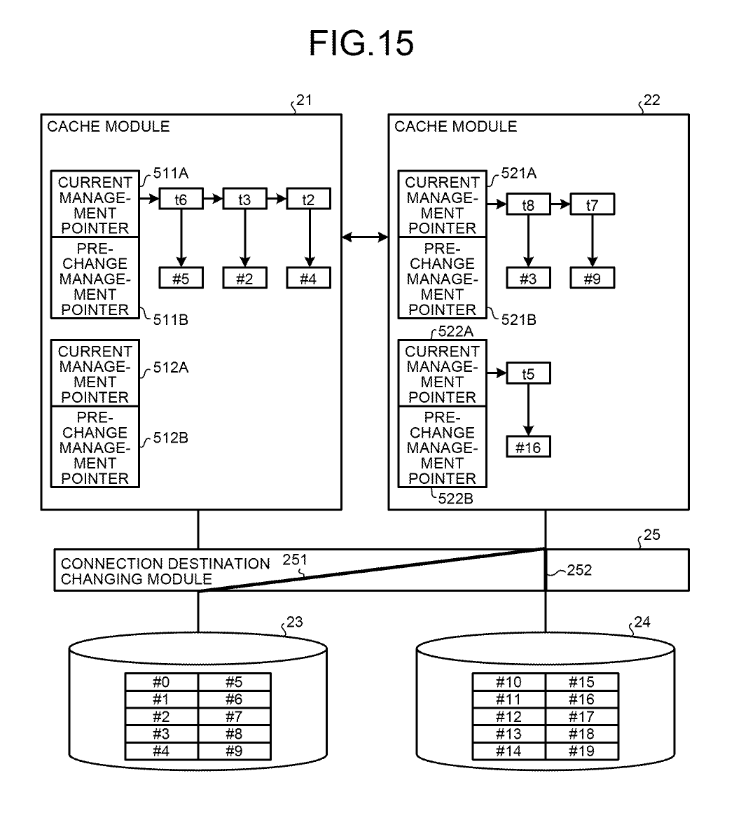

FIG. 12 is a schematic diagram illustrating the state of a storage device according to a third embodiment before a change is performed. FIG. 13 is a schematic diagram illustrating the state of the storage device according to the third embodiment immediately after the change has been performed. FIG. 14 is a schematic diagram illustrating a movement of a cache page when data specified by a read request by the storage device according to the third embodiment is present in a cache memory at the move destination. FIG. 15 is a schematic diagram illustrating a movement of a cache page when the data specified by the read request by the storage device according to the third embodiment is present in a cache memory at the move source. In FIGS. 12 to 15, for convenience of explanation, units included in the cache module 21 are not illustrated. In a description below, a description will be given of a cache module as the subject of the operation; however, in practice, the units described above perform the process.

A current management pointer 511A is a current management pointer for the storage module 23. A pre-change management pointer 511B is a pre-change management pointer for the storage module 23. A current management pointer 512A is a current management pointer for the storage module 24. A pre-change management pointer 512B is a pre-change management pointer for the storage module 24. A current management pointer 521A is a current management pointer for the storage module 23. A pre-change management pointer 521B is a pre-change management pointer for the storage module 23. A current management pointer 522A is a current management pointer for the storage module 24. A pre-change management pointer 522B is a pre-change management pointer for the storage module 24.

Furthermore, in a description below, it is assumed that the move destination cache page count that is set in the cache module 22 is 2. Furthermore, it is assumed that the upper limit of the cache page count that can be stored in the cache module 22 is 3.

Before a change, as illustrated in FIG. 12, the connection path 251 for the storage module 23 is connected to the cache module 21. Furthermore, the connection path 252 for the storage module 24 is connected to the cache module 22.

The cache pages that store therein one of the pieces of the data #2, #3, and #5 are allocated to the current management pointer 511A in the storage module 23 in the cache module 21. Furthermore, because the cache pages are allocated, the cache pages that store therein one of the pieces of the data #4 and #8 and that are stored in the storage module 24 are allocated to the current management pointer 521A in the cache module 22 that manages the storage module 24. Furthermore, the cache page that stores therein the data #16 is allocated to the current management pointer 522A.

Then, if the state of the connection destination of the storage module 23 illustrated in FIG. 12 is changed from the cache module 21 to the cache module 22, the state becomes the state illustrated in FIG. 13. Namely, the connection destination of the connection path 251 for the storage module 23 is changed from the cache module 21 to the cache module 22. Namely, in this case, the cache module 21 becomes the move source and the cache module 22 becomes the move destination. Furthermore, the cache module 22 reallocates the cache pages that stores therein one of the pieces of the data #4 and #8 in the storage module 24 from the current management pointer 521A to the pre-change management pointer 521B.

Then, when the cache module 22 receives a read request for the data #9, the cache module 22 checks that the data #9 is present in neither of the cache pages in the cache modules 21 and 22. Then, the cache module 22 reads the data #9 from the storage module 23. Then, the cache module 22 allocates the cache page that is to be used to store the read data #9 to the current management pointer 521A. At this time, the cache module 22 sets the access time of the cache page that is to be used to store the data #9 to the most recent access time t7. Furthermore, the cache module 22 purges the cache page that stores therein the data #8 with the access time t1 that is the oldest access time from among the cache pages allocated in the pre-change management pointer 521B. Consequently, the storage device 2 becomes the state illustrated in FIG. 14.

Then, if the cache module 22 receives a read request for the data #3, the cache module 22 checks that the cache module 21 holds the cache page that stores therein the data #3. Then, the cache module 22 specifies, as the cache page targeted for an exchange, the cache page that stores therein the data #4 with the access time t2 that is the oldest access time from among the cache pages allocated in the pre-change management pointer 521B. Then, the cache module 22 acquires the cache page that is to be used to store the data #3 from the cache module 21 and sends the cache page that is to be used to store the data #4 to the cache module 21. Consequently, the storage device 2 becomes the state illustrated in FIG. 15.

Furthermore, as described above, in addition to this, there is a case in which a read request for data that is allocated to the pre-change management pointer 521B is received. In such a case, the cache module 22 just simply changes the allocation of cache pages to the current pointer 521A; therefore, a description thereof will be omitted.

As described above, the storage device according to the third embodiment adds, immediately after the connection change, information indicating that a cache page stored before a change to the cache page that has been held before the change and then moves the cache page in accordance with a read request. With such a method, it is also possible to move a cache page and thus the use efficiency of a storage device can be improved.

### [d] Fourth Embodiment

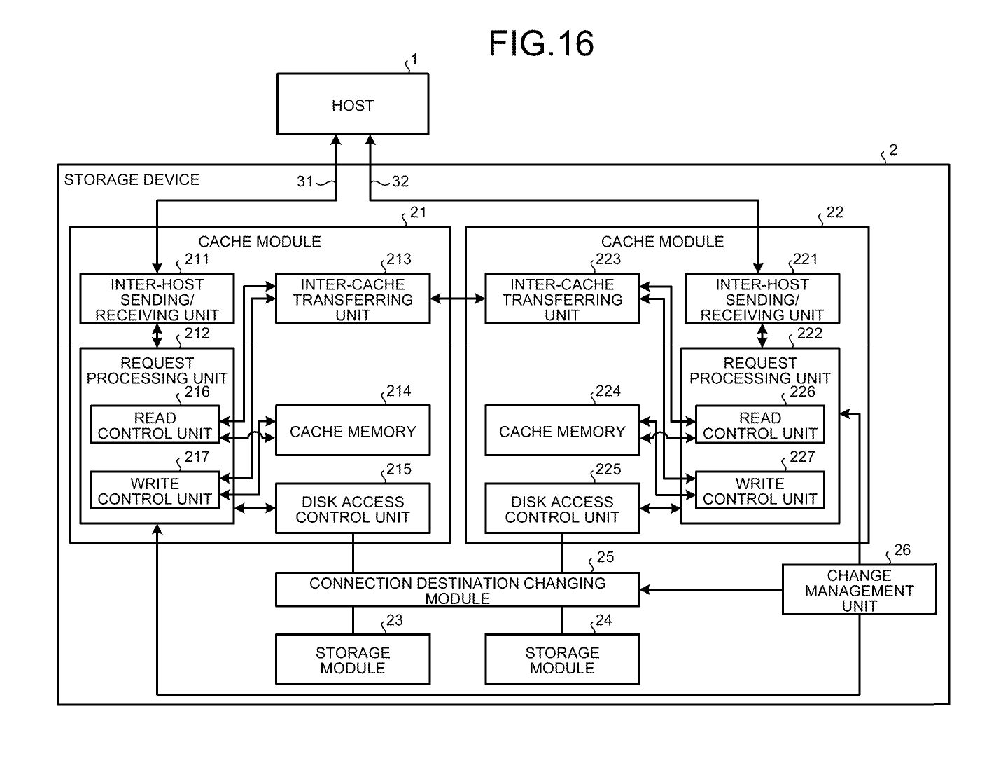

In the following, a fourth embodiment will be described. FIG. 16 is a block diagram illustrating an information processing apparatus according to a fourth embodiment. A storage module according to the fourth embodiment differs from that described in the first to the third embodiments in that the storage module returns OK at the time of storing data in a cache module when the data is written in accordance with a write request and, thereafter, writes the data into a disk. The writing of disk thereafter may sometimes be referred to a write back. In the fourth embodiment, a description will be given of a case in which a function is added to the configuration described in the first embodiment. An information processing apparatus according to the fourth embodiment is also represented by the block diagram illustrated in FIG. 1. In a description below, descriptions of processes performed by the units described in the second embodiment will be omitted. In particular, a movement of a cache page requested by a read request at the time of connection change is the same as that of the embodiments described above; therefore, a description thereof will be omitted.

The request processing unit 212 includes a write control unit 217. Furthermore, the request processing unit 222 includes a write control unit 227. Because the write control unit 217 and the write control unit 227 have the same function, in the following, a description will be given of the write control unit 217 as an example.

When the write control unit 217 receives, from the inter-host sending/receiving unit 211, a write request with respect to the storage module 23, the write control unit 217 writes data specified by the write request in the cache memory 214. The write control unit 217 shares the cache control table 100 (see FIG. 2) with the read control unit 216. Furthermore, the write control unit 217 writes, in the cache control table 100, information related to a cache page that stores therein data written in the cache memory 214. At this time, the write control unit 217 sets the write flag 105 to “written”. The data stored in the cache page with the write flag 105 of written is not deleted from the cache module.

Thereafter, when the writing of the data into the cache memory 214 has been completed, the write control unit 217 sends, to the host 1 via the inter-host sending/receiving unit 211, a completion notification of the writing.

Then, the write control unit 217 writes back, to the storage module 23, the data in the cache page with the write flag that is stored in the cache page and that indicates “written” if the state is as follows. Namely, if no space for storing the data is present in the cache module 21 when the data is stored and if the write flag of the cache page with the oldest access time indicates “written”, the write control unit 217 performs a write back. Furthermore, when a predetermined time has elapsed since the data was stored, the write control unit 217 performs the write back.

Furthermore, after the completion of the writing of the data into the cache memory 214, if a connection change in which the cache module 21 is used as the move source occurs, the write control unit 217 sends, to the write control unit 227 when a write back is performed, the data to be written back.

After the completion of the writing of the data, which is to be written back to the storage module 24, into the cache memory 214, if a connection change in which the cache module 21 is used as the move destination, the write control unit 217 receives, from the write control unit 227, the data to be written back. Then, the write control unit 217 writes back the received data to the storage module 24. Then, after the completion of the write back, the write control unit 217 sends, to the write control unit 227, a completion notification of the write back.

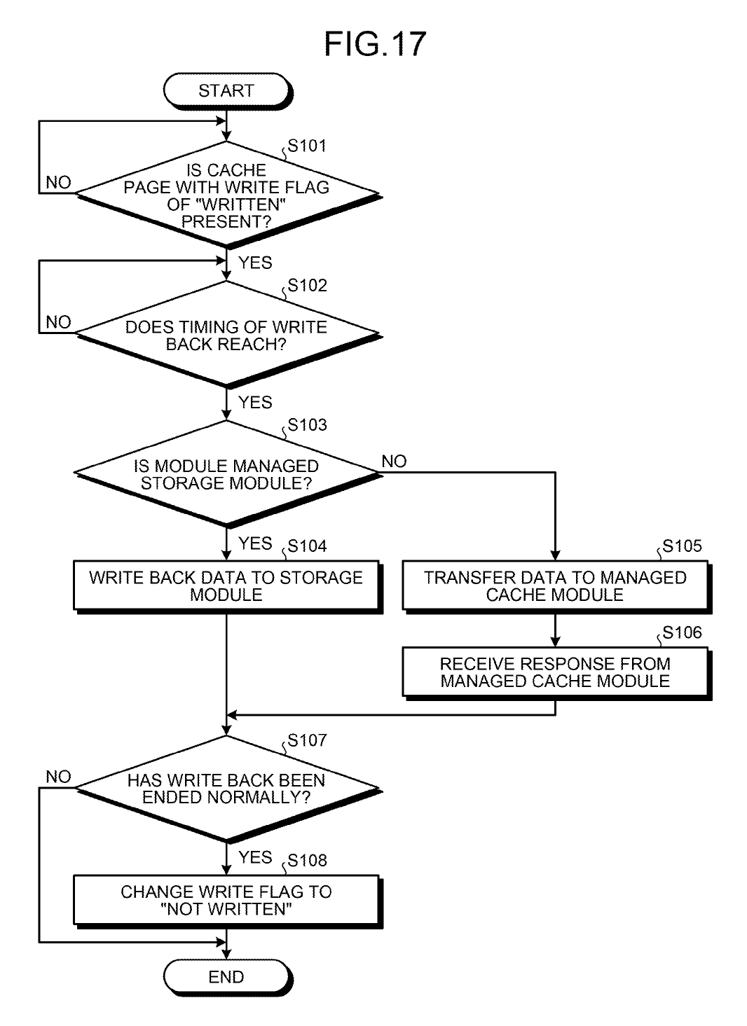

In the following, a process, performed by a cache module, of writing back cache data will be described with reference to FIG. 17. FIG. 17 is a flowchart illustrating the flow of a process, performed by a cache module, of performing a write back of cache data. Here, a description will be given of a case in which the cache module 21 performs a write back with respect to the storage module 23.

The write control unit 217 determines whether cache data with the write flag of “written” is present in the cache memory 214 (Step S101). If the cache data with the write flag of “written” is not present (No at Step S101), the write control unit 217 waits until the cache data with the write flag of “written” is written in the cache memory 214.

In contrast, if the cache data with the write flag of “written” is present (Yes at Step S101), the write control unit 217 determines whether the timing of a write back reaches (Step S102). If the timing of the write back has not reached (No at Step S102), the write control unit 217 waits until the timing of the write back reaches.

In contrast, if the timing of the write back has reached (Yes at Step S102), the write control unit 217 determines whether the storage module 23 is to be managed by the cache module 21 (Step S103). For example, when the data is stored in the cache memory 214, the cache module 21 manages the storage module 23; however, if a connection change occurs thereafter, the cache module 21 does not manage the storage module 23 anymore.

If the storage module 23 is managed by the cache module 21 (Yes at Step S103), the write control unit 217 writes back the data stored in the cache memory 214 to the storage module 23 (Step S104).

In contrast, if the storage module 23 is not managed by the cache module 21 (No at Step S103), the write control unit 217 transfers data to the write control unit 227 in the cache module 22 that manages the storage module 23 (Step S105).

Thereafter, the write control unit 217 receives a response from the write control unit 227 in the cache module 22 (Step S106).

Then, the write control unit 217 determines whether the write back is ended normally (Step S107). For example, if a connection change occurs during a write back to the storage module 23, an error occurs. If the write back is not ended normally (No at Step S107), the write control unit 217 ends the write back process performed this time.

In contrast, if the write back is ended normally (Yes at Step S107), the write control unit 217 changes the write flag of the cache page that is to be used to store the written back data to “not written” (Step S108). Then, the write control unit 217 ends the write back process.

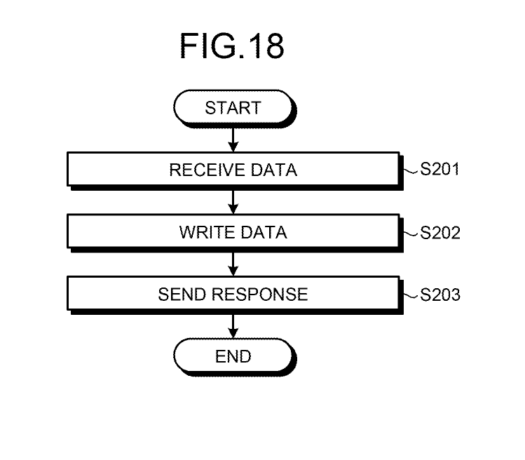

In the following, a process, performed by a cache module, of writing transferred write back data will be described with reference to FIG. 18. FIG. 18 is a flowchart illustrating the flow of a process, performed by the cache module, of writing transferred write back data. Here, a description will be given of a case in which the cache module 22 writes the write back data transferred from the cache module 21 into the storage module 23.

The write control unit 227 receives the write back data from the write control unit 217 (Step S201).

Then, the write control unit 227 writes the received data into the storage module 23 (Step S202).

Then, the write control unit 227 sends, to the write control unit 217, a response indicating the result of the process of writing the data (Step S203).

As described above, the storage device according to the fourth embodiment can acquire, from a cache module at the move source when a connection change occurs, data to be written back and write the data into the target storage module. Consequently, when cache data is written back to a disk, even if a change occurs, the data that was stored in the cache module at the move source is not cleared; therefore, there is no need to take time to clear the data. In this way, cache data that was held by a cache module before a change can be effectively used and thus the performance of the storage module can be improved.

(Hardware Configuration)

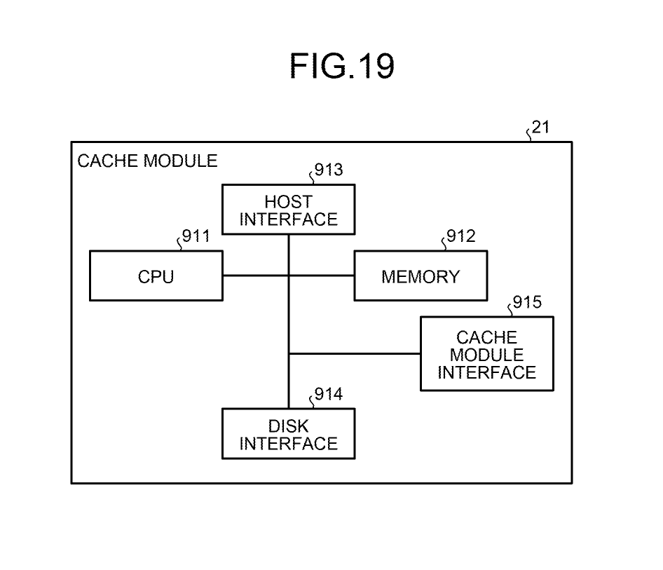

In the following, the hardware configuration of the cache modules 21 and 22 according to the embodiments will be described with reference to FIG. 19. FIG. 19 is a block diagram illustrating an example of the hardware configuration of a cache module.

As illustrated in FIG. 19, the cache module 21 includes a central processing unit (CPU) 911, a memory 912, a host interface 913, a disk interface 914, and a cache module interface 915.

The memory 912, the host interface 913, the disk interface 914, and the cache module interface 915 are connected to the CPU 911 via a bus.

The host interface 913 is an interface with the host 1. The host interface 913 receives an I/O request from the host 1. Furthermore, the host interface 913 sends a response to the I/O request to the host 1.

The disk interface 914 is an interface that is used to connect to the storage modules 23 and 24. The disk interface 914 sends an I/O request to the storage modules 23 and 24.

The cache module interface 915 is an interface that is used to connect to the cache module 22. The cache module interface 915 sends and receives an I/O request to and from the cache module 22.

The memory 912 includes the cache memory 214. Furthermore, in the memory 912, various programs including programs for implementing each of the functions performed by the inter-host sending/receiving unit 211, the request processing unit 212, the inter-cache transferring unit 213, the disk access control unit 215, the read control unit 216, and the write control unit 217 illustrated in FIG. 1 or 16 as an example.

The CPU 911 reads various programs from the memory 912 and executes the programs. Consequently, the CPU 911 and the memory 912 implement each of the functions performed by the inter-host sending/receiving unit 211, the request processing unit 212, the inter-cache transferring unit 213, the disk access control unit 215, the read control unit 216, and the write control unit 217 described as an example in the first embodiment.

According to an aspect of an embodiment of the storage device, the information processing apparatus, the cache control program, and the cache control method disclosed in the present invention, an advantage is provided in that cache data that was included in a cache module before a change can be effectively used.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a first storing unit;
a second storing unit;
a first cache memory that is connected to the first storing unit and that stores therein part of information stored in the first storing unit;
a second cache memory that is connected to the second storing unit and that stores therein part of information stored in the second storing unit;
an information processing unit that reads or writes information with respect to the first storing unit and the second storing unit, by using the information stored in the first cache memory or the second cache memory;
a change management unit that changes connection such that the first storing unit is connected to the second cache memory; and
a move unit that moves, when the change is performed by the change management unit, the information stored in the first cache memory to the second cache memory.

2. The storage device according to claim 1, wherein the move unit performs the movement on the basis of a use frequency of the information stored in the first cache memory and the second cache memory.

3. The storage device according to claim 1, wherein the move unit performs the movement on the basis of an access history of the information stored in the first cache memory and the second cache memory.

4. The storage device according to claim 3, wherein the move unit moves pieces of information stored in the first cache memory in the order that a timing at which the information is accessed is new.

5. The storage device according to claim 2, wherein, when free space in the second cache memory that is to be used for the movement of the information stored in the first cache memory is insufficient, the move unit discards pieces of information, from among the pieces of the information stored in the second cache memory, in the order that a timing at which the information is accessed is old.

6. The storage device according to claim 3, wherein, when free space in the second cache memory that is to be used for the movement of the information stored in the first cache memory is insufficient, the move unit discards pieces of information, from among the pieces of the information stored in the second cache memory, in the order that a timing at which the information is accessed is old.

7. The storage device according to claim 1, wherein
the first cache memory and the second cache memory are connected with each other and manage part of information stored in the other one of the storing units,
when the first cache memory is connected to the first storing unit and when the second cache memory is connected to the second storing unit, the information processing unit uses, in a process performed on one of the first storing unit and the second storing unit, the information stored in the first cache memory or the second cache memory, and
when a change is performed by the change management unit, the move unit changes the information that is stored in the first storing unit and that is stored in the second cache memory to the information, from among the pieces of the information that is stored in the first storing unit and that is stored in the first cache memory, in which access timing is newer than the access timing of the information that is stored in the first storing unit and that is stored in the second cache memory.

8. The storage device according to claim 1, wherein
the first cache memory and the second cache memory are connected with each other and manage part of information stored in the other one of the storing units,
when the first cache memory is connected to the first storing unit and when the second cache memory is connected to the second storing unit, the information processing unit uses, in a process performed on one of the first storing unit and the second storing unit, the information stored in the first cache memory or the second cache memory, and
when a change is performed by the change management unit, the move unit adds pre-change information to the information that is stored in the first storing unit and that is stored in the second cache memory and performs the movement on the basis of an access history of the information stored in the first cache memory and the second cache memory and on the basis of the pre-change information.

9. The storage device according to claim 7, wherein
when information specified by a processing request is stored in the first cache memory, the move unit exchanges, from among the pieces of information to which the pre-change information is added, information with the oldest access timing for information that is specified by the processing request,
when the information specified by the processing request is not present in the first cache memory and the second cache memory, the move unit deletes the information with the oldest access timing from among the pieces of the information to which the pre-change information is added and stores the information that is specified by the processing request, and
when the information specified by the processing request is the information to which the pre-change information is added, the move unit deletes the pre-change information from the information.

10. The storage device according to claim 1, wherein
when the first cache memory is connected to the first storing unit and when a processing request for information to be written into the first storing unit is received, the information processing unit stores, in the first cache memory, the information that is to be written into the first storing unit,
when the change is not performed by the change management unit, the information processing unit writes, into the first storing unit, the information that is to be written into the first storing unit and that is stored in the first cache memory,
when a change is performed by the change management unit, the information processing unit writes, into the first storing unit, the information that is to be written into the first storing unit and that is stored in the second cache memory, and
when the change is performed by the change management unit, the move unit moves the information that is to be written into the first storing unit and that is stored in the first cache memory to the second cache memory.

11. An information processing apparatus comprising:
an arithmetic processing unit; and
a storage device, wherein
the arithmetic processing unit requests the storage device to read or to write information, and
the storage device includes
a first storing unit;
a second storing unit,
a first cache memory that is connected to the first storing unit and that stores part of information stored in the first storing unit,
a second cache memory that is connected to the second storing unit and that stores therein part of information stored in the second storing unit,
an information processing unit that reads or writes information from or to the first storing unit and the second storing unit, by using the information stored in the first cache memory or the second cache memory,
a change management unit that changes connection such that the first storing unit is connected to the second cache memory, and
a move unit that moves, when the change is performed by the change management unit, the information stored in the first cache memory to the second cache memory.

12. A computer-readable recording medium having stored therein a cache control program in a storage device that includes a first storing unit, a second storing unit, a first cache memory, and a second cache memory, the cache control program causing a computer to execute a process comprising:
connecting the first cache memory to the first storing unit and storing, in the first cache memory, part of information stored in the first storing unit;
connecting the second cache memory to the second storing unit and storing, in the second cache memory, part of information stored in the second storing unit;
reading or writing information with respect to the first storing unit and the second storing unit, by using the information stored in the first cache memory or the second cache memory;
changing connection such that the first storing unit is connected to the second cache memory; and
moving, at the time of the changing, the information stored in the first cache memory to the second cache memory.
